(19) United States
(12) Patent Application Publication
(10) Pub. No.: US 2018/0149826 A1
(43) Pub. Date: May 31, 2018

(54) TEMPERATURE-ADJUSTED FOCUS FOR CAMERAS

(71) Applicant: Microsoft Technology Licensing, LLC, Redmond, WA (US)

(72) Inventors: Maria C. LEI, Bellevue, WA (US); Hang LI, Bellevue, WA (US); Vishal JAIN, Redmond, WA (US); Eric F. AAS, Windsor, CO (US); Kevin J. MATHERSON, Windsor, CO (US)

(21) Appl. No.: 15/362,689

(22) Filed: Nov. 28, 2016

(51) Int. Cl. G02B 7/02; G02B 7/08; G02B 7/28; G02B 5/32; H04N 5/225; H04N 5/232

(52) U.S. Cl. CPC G02B 7/028; G02B 7/08; H04N 5/23293; G02B 5/32; H04N 5/2254; G02B 7/28

(57) ABSTRACT

Described are examples of a computing device that includes a camera with a lens configured to capture a real world scene for storing as a digital image. The computing device also includes at least one processor configured to determine a temperature related to the lens of the camera, apply, based on the temperature, an offset to at least one of a lens position or range of lens positions defined for the lens, and perform a focus of the lens based on at least one of the lens position or range of lens positions.

### BACKGROUND

Cameras can employ auto-focus algorithms to focus a lens of the camera by selecting a focus for the lens that maximizes contrast of the real world scene as captured by the lens. The auto-focus algorithms can adjust the lens position within a range to obtain a collection of images, and can compare the contrast of the resulting images to determine an optimal lens position. This process can take some time and can be made visible during video capture by display of blurred images while the lens is focusing. Also, this process is generally agnostic to variations in effective focal length. In addition, cameras can use an external scene depth source to control the focus, or corresponding movement, of the lens in selecting the focus. In this configuration, the external scene depth source can provide scene depth information to the camera, and the camera can determine a lens adjustment for focusing the lens based on a current object focus distance and the scene depth information. In addition, in this configuration, the camera can still attempt to auto-focus the real world scene based on contrast at the scene depth.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a computing device is provided including a camera having a lens configured to capture a real world scene for storing as a digital image. The computing device also includes at least one processor configured to determine a temperature related to the lens of the camera, apply, based on the temperature, an offset to at least one of a lens position or range of lens positions defined for the lens, and perform a focus of the lens based on at least one of the lens position or range of lens positions.

In another example, a method for focusing a lens of a camera is provided. The method includes determining a temperature related to the lens of the camera, applying, based on the temperature, an offset to at least one of a lens position or range of lens positions defined for the lens, and performing a focus of the lens based on at least one of the lens position or range of lens positions.

In another example, a non-transitory computer-readable medium including code for focusing a lens of a camera is provided. The code includes code for determining a temperature related to the lens of the camera, code for applying, based on the temperature, an offset to at least one of a lens position or range of lens positions defined for the lens, and code for performing a focus of the lens based on at least one of the lens position or range of lens positions.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a computing device for adjusting a position or range of positions for a lens of a camera.

FIG. 2 is a flow diagram of an example of a method for applying an offset to one or more parameters related to a lens position.

FIG. 3 is a schematic diagram of an example of a focus range corresponding to a lens position with and without temperature adjustment.

FIG. 4 is a flow diagram of an example of a process for modifying a position or range of positions of a lens.

FIG. 5 is a schematic diagram of an example of a computing device for performing functions described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Described herein are various examples related to setting one or more parameters for focusing a lens of an image sensor (also referred to generally herein as a “camera”) based on a temperature of, or as measured near, the lens. For example, a temperature of, or near, the lens of the image sensor can be determined, and the temperature can be used to control a lens position or range of lens positions, relative to the image sensor, to improve performance in focusing the lens. Variations in temperature of the lens, which may be caused by repeated use of the mechanics of the lens in performing auto-focus, or by ambient temperature, or by any other mechanism that may cause temperature variation, may affect lens curvature, which can result in variation of effective focal length at the image sensor. For example, changes in lens curvature can cause variation in the lens-to-image sensor distance for optimal focus of a particular object. This variation can cause issues when an auto-focus algorithm uses external scene depth information to control the lens movement because image sensor auto-focus processes can focus the lens at various object distances by associating a specific lens position with a specific object distance as determined at a calibrated lens temperature. In other words, variations in temperature of the lens cause the image sensor auto-focus processes to adjust the lens position relative to the image sensor for a given object distance due to the focal length of the lens changing as a function of temperature. Thus, as described herein, applying an offset to one or more parameters for focusing the lens can account for the temperature-based change in lens curvature, which can assist in focusing the lens based on scene depth information and/or which can enhance performance of auto-focus processes. The offset, for example, may correspond to an actuator position for focusing the lens, a change in a current actuator position, etc., and may correspond to a distance to move the lens relative to the image sensor (e.g., a number of micrometers or other measurement).

Specifically, for example, an offset for one or more parameters, such as a lens position or range of lens positions relative to the image sensor, can be determined based on the measured temperature, and used to adjust the lens position or range of lens positions of the lens relative to the image sensor. In an example, at least one of an association of temperatures (or ranges of temperatures) and lens position offsets, a function for determining lens position offset based on temperature, etc. can be received (e.g., as stored in a memory of the image sensor or an actuator for the lens, such as in a hardware register), and used to determine an offset to apply to the lens position or range of lens positions based on the measured temperature. The image sensor can accordingly set the lens position or range of lens positions for determining focus based on applying the offset. This can mitigate effects caused by the variation in effective focal length (EFL) due to temperature.

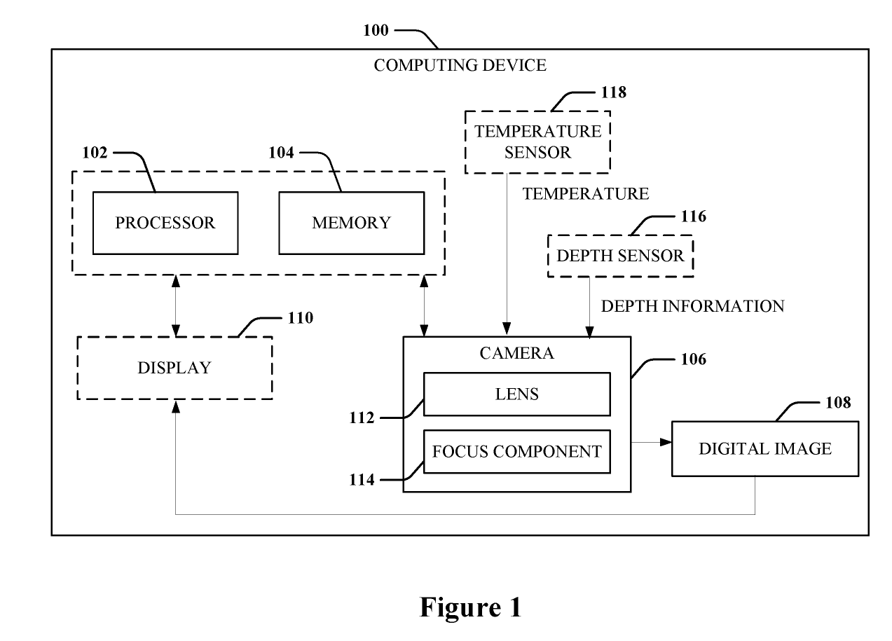

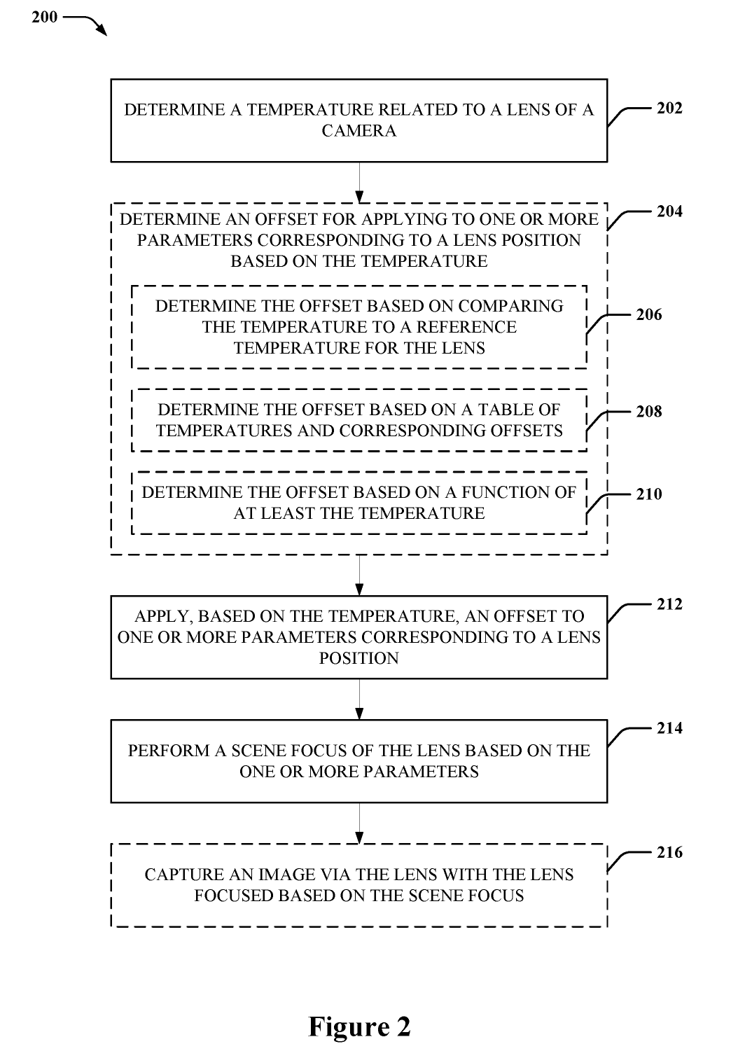

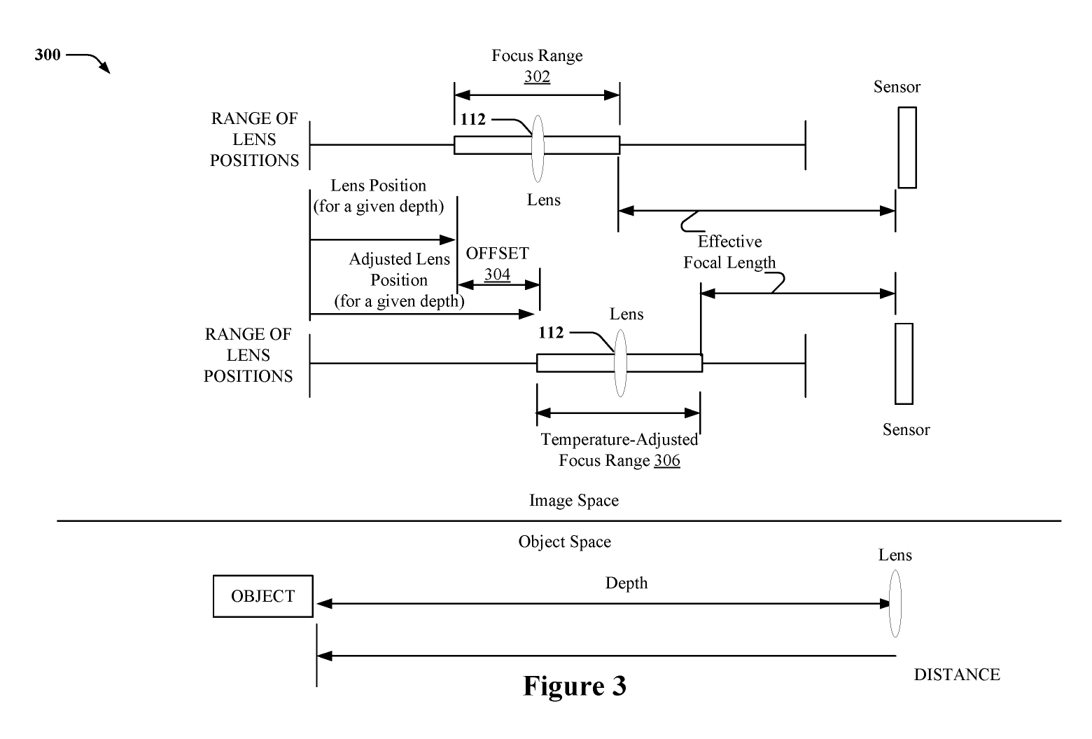

Turning now to FIGS. 1-5, examples are depicted with reference to one or more components and one or more methods that may perform the actions or operations described herein, where components and/or actions/operations in dashed line may be optional. Although the operations described below in FIGS. 2 and 3 are presented in a particular order and/or as being performed by an example component, the ordering of the actions and the components performing the actions may be varied, in some examples, depending on the implementation. Moreover, in some examples, one or more of the following actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a computing device 100 that can include a processor 102 and/or memory 104 configured to execute or store instructions or other parameters related to operating a camera 106 for generating a digital image 108 corresponding to a real world scene. The computing device 100 can also optionally include a display 110 for displaying, e.g., via instructions from the processor 102, one or more of the digital images captured by the camera 106, which may be stored in memory 104. The camera 106 can include a lens 112 for capturing the real world scene for processing as a digital image 108. The lens 112 can include a simple lens or a compound lens. The lens 112 can be focusable via a focus component 114 to generate the digital image as focused at a focal point corresponding to one or more objects in the digital image. The focus component 114 can include, but is not limited to, an actuator, which can be coupled with the lens 112, to move the lens 112 relative to the camera to achieve a desired focus of an image captured through the lens 112. Moreover, for example, the focus component 114 may include a processor for operating the actuator to move the lens 112 among specified positions, among a range of positions, etc., as described herein. In an example, focus component 114 can focus the lens 112 based on performing an auto-focus process to compare a level of contrast of images captured at different lens positions (e.g., a position of the entire lens 112 or of one or more lenses within the lens 112) relative to the camera 106 to determine an image having a most optimal contrast. In an example, the computing device 100 and/or camera 106 can include a depth sensor 116 to determine depth information of one or more objects in the real world scene to indicate a depth at which the camera 106 should be focused. In another example, computing device 100 and/or camera 106 can include a temperature sensor 118 to measure a temperature at or near camera 106 or lens 112 for modifying a position of the lens 112, or range of positions of the lens 112, based on the temperature. For example, the temperature sensor 118 may include, but is not limited to, a thermistor, thermocouple, or other thermal detecting element that can provide a signal to a processor indicating a measured temperature or a temperature delta from a reference temperature. Moreover, for example, camera 106 may be a 2D camera, a 3D camera, and/or the like.

As described, temperature can affect a curvature of the lens 112, and hence a focal length of the lens 112 at a given lens position, which can result in the focus component 114 having to change of a position of the lens 112 relative to the camera 106 in order to properly focus the camera 106 on an object at a given depth. A temperature at or near the lens 112 may affect an effective focal length of the lens 112 to focus on an object at a certain distance from the lens 112 in the real world scene. For instance, where focus component 114 focuses the camera 106 based at least in part on specified depth information (e.g., from a depth sensor or other source, such as a mixed reality application), the expected focal length to focus on an object at the specified depth may be different from the actual focal length based on the temperature of the lens. This issue may also manifest in auto-focus processes performed by the focus component 114, as auto-focus processes can typically determine a range of distances for moving the lens 112 to achieve focus at an indicated depth. In this example, focus component 114 can define a focus range of distances for moving the lens 112 (e.g. via an actuator), where the range is calibrated for the infinity and macro positon points. The calibration can typically be performed based on a temperature of the lens 112 during calibration, which is referred to herein as a “calibrated lens temperature” or a “reference temperature.” Thus, at other temperatures of the lens 112, the calibration may not be optimal as the different temperatures can result in changes to lens 112 curvature, and thus effective focal length.

Accordingly, in an example, the temperature sensor 118 can be positioned on the computing device 100, e.g., near the camera 106, on the camera 106, near the lens, on the lens 112, etc., for measuring a temperature of the lens 112, an ambient temperature near the lens 112, etc. Based at least in part on the temperature, for example, focus component 114 can adjust a position of the lens 112, or a range of positions of the lens 112 for performing an auto-focus process, for capturing the digital image 108. This can provide the auto-focus process with a more accurate focal length (e.g., a temperature-adjusted focal length) for positioning the lens 112 for capturing an in-focus version of the digital image 108, allow a more efficient auto-focus process for capturing the digital image 108 based on the more accurate focal length for the lens 112, etc. For example, modifying the range of positions of the lens 112 based on the temperature can reduce a number of movements of the lens 112 for capturing of images as part of the auto-focus process, which can reduce the time for performing the auto-focus process, reduce a number of out-of-focus images displayed on display 110 during performing the auto-focus process, etc.

FIG. 2 is a flowchart of an example of a method 200 for adjusting a lens position of a camera based on temperature. For example, method 200 can be performed by a computing device 100 having a camera 106, a camera 106 without a computing device 100 (e.g., but having a processor 102 and/or memory 104), etc. to facilitate adjusting a lens position for capturing one or more images.

In method 200, at action 202, a temperature related to a lens of a camera can be determined. In an example, temperature sensor 118, e.g., in conjunction with processor 102, memory 104, etc., can determine the temperature related to the lens 112 of the camera 106. For example, the temperature sensor 118 can be positioned at or near the camera 106 or lens 112 of the camera 106, as described, to measure a temperature around or at the lens 112 of the camera 106. For example, the temperature can accordingly correspond to an operating temperature of the lens 112 and/or corresponding mechanics (e.g., an actuator) used to focus or move the lens 112), an ambient temperature near the lens 112 or camera 106, etc. As described, the temperature of the lens 112 can affect lens curvature and focal length, and thus can be used to modify one or more parameters related to a position of the lens 112 to account for the temperature and temperature-induced change in the focal length.

In method 200, optionally at action 204, an offset for applying to one or more parameters corresponding to a lens position can be determined based on the temperature. In an example, focus component 114, e.g., in conjunction with processor 102, memory 104, etc., can determine the offset for applying to the one or more parameters corresponding to the lens position (e.g., of lens 112) based on the temperature received from the temperature sensor 118. For example, the offset can be a value, e.g., a distance or a change in distance, to which or by which the lens position is to be changed to compensate for the change in lens curvature and focal length based on the temperature.

In an example, in determining the offset at action 204, optionally at action 206, the offset can be determined based on comparing the temperature to a reference temperature for the lens. In an example, focus component 114, e.g., in conjunction with processor 102, memory 104, etc., can determine the offset based on comparing the temperature to a reference temperature for the lens 112. As described, for example, lens 112 can be calibrated with lens positions for achieving focus at a specified depth, ranges of lens positions for performing auto-focus (e.g., at a specified depth or otherwise), and/or the like. This calibration can be performed at a certain lens temperature, referred to herein as the reference temperature. The reference temperature may be determined when calibrating the lens 112 and may be included in a configuration of the camera 106 (e.g., in memory 104). Accordingly, in one example, focus component 114 can compare the temperature measured by the temperature sensor 118 to the reference temperature to determine a change or difference in temperature at the lens 112 (e.g., by subtracting the reference temperature from the temperature measured by temperature sensor 118). Focus component 114, in an example, may use the change in temperature or the temperature measured by the temperature sensor 118 to determine the offset, as described further herein.

In another example, in determining the offset at action 204, optionally at action 208, the offset can be determined based on a table of temperatures and corresponding offsets. In an example, focus component 114, e.g., in conjunction with processor 102, memory 104, etc., can determine the offset based on the table of temperatures and corresponding offsets. For example, the table can be stored in a memory (e.g., memory 104, which may include a hardware register) of the camera 106, focus component 114 (e.g., actuator), and/or computing device 100. The table may correlate temperature values (e.g., as an actual temperature or change from a reference temperature), or ranges of such temperature values, with values of the offset. For example, the higher the temperature value, the higher the value of the offset may be to account for changes in curvature of the lens 112.

In another example, in determining the offset at action 204, optionally at action 210, the offset can be determined based on a function of at least the temperature. In an example, focus component 114, e.g., in conjunction with processor 102, memory 104, etc., can determine the offset based on the function of at least the temperature (e.g., the actual temperature from temperature sensor 118 or the determined change in temperature from a reference temperature). For example, the function may be a linear or non-linear function that correlates change in temperature to the offset value.

In any case, for example, the table of temperatures/ranges of temperatures and offset values, the function, etc. may be configured in a memory 104 of the camera 106 and/or computing device 100, provided by one or more remote components, provided in a driver for the camera 106 in an operating system of the computing device 100, etc.

In method 200, at action 212, an offset (e.g., the offset determined at actions 204, 206, 208, and/or 210), based on the temperature, can be applied to one or more parameters corresponding to a lens position. In an example, focus component 114, e.g., in conjunction with processor 102, memory 104, etc., can apply, based on the temperature, the offset to the one or more parameters corresponding to the lens position. For example, focus component 114 can apply the offset (e.g., by adding a value of the offset) to such parameters as a position of the lens 112 relative to the camera 106, a range of positions of the lens 112 relative to the camera 106 (e.g., for performing an auto-focus process), etc. Applying the offset to adjust the position of the lens 112, or range of positions of the lens 112, in this regard, can allow for compensating changes in lens curvature and the corresponding change in focal length caused by change in temperature of the lens, which can result in better-focused images, faster auto-focus processing, etc.

In one example, the one or more parameters corresponding to the lens position may be set based on received depth information (e.g., from depth sensor 116 or another source), and the temperature can be used to adjust or set one or more parameters. For example, camera 106 can operate to provide digital images 108 based on one or more focal points. In one example, camera 106 can accept input as to a depth at which to focus the lens 112 for capturing the digital images 108. In one example, depth sensor 116 can be used to determine a depth of one or more real world objects corresponding to a selected focal point for the image. In this example, focus component 114 can set a position of the lens 112 based on the depth of the selected focal point and/or can set a range of positions for the lens 112 for performing an auto-focus process based on the focal point. This mechanism for performing the auto-focus process can be more efficient than attempting to focus over all possible lens positions.

In another example, camera 106 may operate to capture images for application of mixed reality holograms to the images. In this example, depth sensor 116 may determine a depth of one or more real world objects viewable through the camera 106, which may be based on a position specified for hologram placement in the mixed reality image (e.g., the placement of the hologram can correspond to the focal point for the image). Determining the depth in this regard can allow the camera 106 to provide focus for one or more objects at the hologram depth, which can provide the appearance of objects around the position of the hologram to be in focus. In either case, depth information can be provided for indicating a desired focal length for the lens 112, from which a position or range of positions of the lens 112 can be determined (as described further in FIG. 3).

In either case, for example, the depth information received from the depth sensor 116, or another source, can be used to determine the position or range of positions (for auto-focus) of the lens 112. As described, however, the lens curvature may be affected by temperature. For example, where the lens curvature and, hence, focal length, is affected by a temperature that is different from the reference temperature (e.g., by at least a threshold), objects in the real world scene may not be at a correct level of focus in the lens 112, though the lens 112 is set at a lens position corresponding to the depth information. Thus, focus component 114 can use not only the depth information but also the temperature in determining the position or ranges of positions for the lens 112. For example, focus component 114 can add the determined offset to the position or range of positions for the lens 112 that correspond to scene focus at the depth indicated by the depth information. This can provide for a more focused image at the depth, expedite the auto-focus process at the depth, etc. An example is illustrated in FIG. 3.

FIG. 3 illustrates an example of a full range of lens positions 300 for a lens (e.g., lens 112) of a camera (e.g., camera 106). For example, the full range of lens positions 300 may include many possible positions along an axis, which may be achieved by an actuator (e.g., focus component 114) moving the lens over the axis. In addition, a focus range 302 can be defined for performing an auto-focus process at a given depth. The focus range 302 can be defined by infinity and macro range values. For example, the infinity value can correspond to an infinity focus where the camera lens 112 is set at a position so that an infinity (far) distant object would be sharp or in focus, and the macro value can correspond to a macro focus where the camera lens 112 is set at a position of a closest distance object—e.g., depending on the lens 112, the closest distance can be different (e.g., 10 cm, 20 cm or 30 cm. In addition, for example, the focus range 302 can be set based at least in part on depth information of an object (e.g., based on a determined relationship between the camera 106, or the position of the lens 112, and depth information received from a depth sensor 116, a mixed reality application, or other depth information source). Thus, as depicted, the focus range 302 can be set to begin at a lens position corresponding to a given depth, and the lens 112 focused within the focus range 302 can provide a focal length. In one example, as described, the focus range 302 can be calibrated at a certain reference temperature.

In any case, for example, temperature variation at the lens 112 can affect the focal length and yield an effective focal length that is different from the focal length expected at the reference temperature. In addition, the extent of the focus range 302 may be affected by temperature (e.g., may lengthen as temperature increases). In this example, the offset 304 can be determined (e.g., by a focus component 114) based on the temperature measured for the lens 112 (e.g., by temperature sensor 118), as described, and can be applied (e.g., by the focus component 114) at least to the focus range 302 to generate a temperature-adjusted focus range 306 for performing the auto-focus process. For example, the offset 304 can be added to the infinity and macro values of focus range 302. In one example, the offset can be a multiple such to account for any change in the extent of the focus range 302. In another example, separate offsets can be defined for the infinity and macro values such to account for any change in the extent of the focus range 302. Using the temperature-adjusted focus range 306 for the auto-focus process may expedite the auto-focus process and/or ensure that the auto-focus process successfully completes, as the focus range is moved to account for effective focal length based on temperature, and can provide a similar expected focus range as the focus range 302 would provide at the reference temperature.

Referring back to FIG. 2, in method 200 at action 214, a focus of the lens can be performed based on the one or more parameters. In an example, focus component 114, e.g., in conjunction with processor 102, memory 104, etc., can perform the focus of the lens (e.g., lens 112) based on the one or more parameters. For example, focus component 114 can perform the focus to provide a focus of the real world scene based on setting the lens position of the lens 112, or range of positions for performing an auto-focus process (e.g., the infinity and macro range values that can correspond to positions of an actuator that moves the lens 112), based on the one or more parameters (e.g., based on the position or range of positions with the offset applied). For example, focus component 114 can perform the auto-focus process based on comparing the contrast levels of different images captured along the range of different lens positions around a desired object focus distance. Thus, setting the range of lens positions as adjusted for temperature may result in more accurate and/or efficient auto-focus process as any change in effective focal length resulting from temperature change can be compensated by offsetting the range of lens positions, and may allow for a lesser number of image captures and contrast level comparisons than where the range of lens positions does not account for variation in lens temperature.

In method 200, optionally at action 216, an image can be captured via the focused lens focused. In an example, camera 106, e.g., in conjunction with processor 102, memory 104, etc., can capture the image via the lens (e.g., lens 112) with the focused lens. In an example, camera 106 can capture the image as or convert the image to digital image 108 as part of the auto-focus process to capture multiple images and compare the contrast level, or as the captured digital image 108 for storing in memory 104, displaying on display 110, etc.

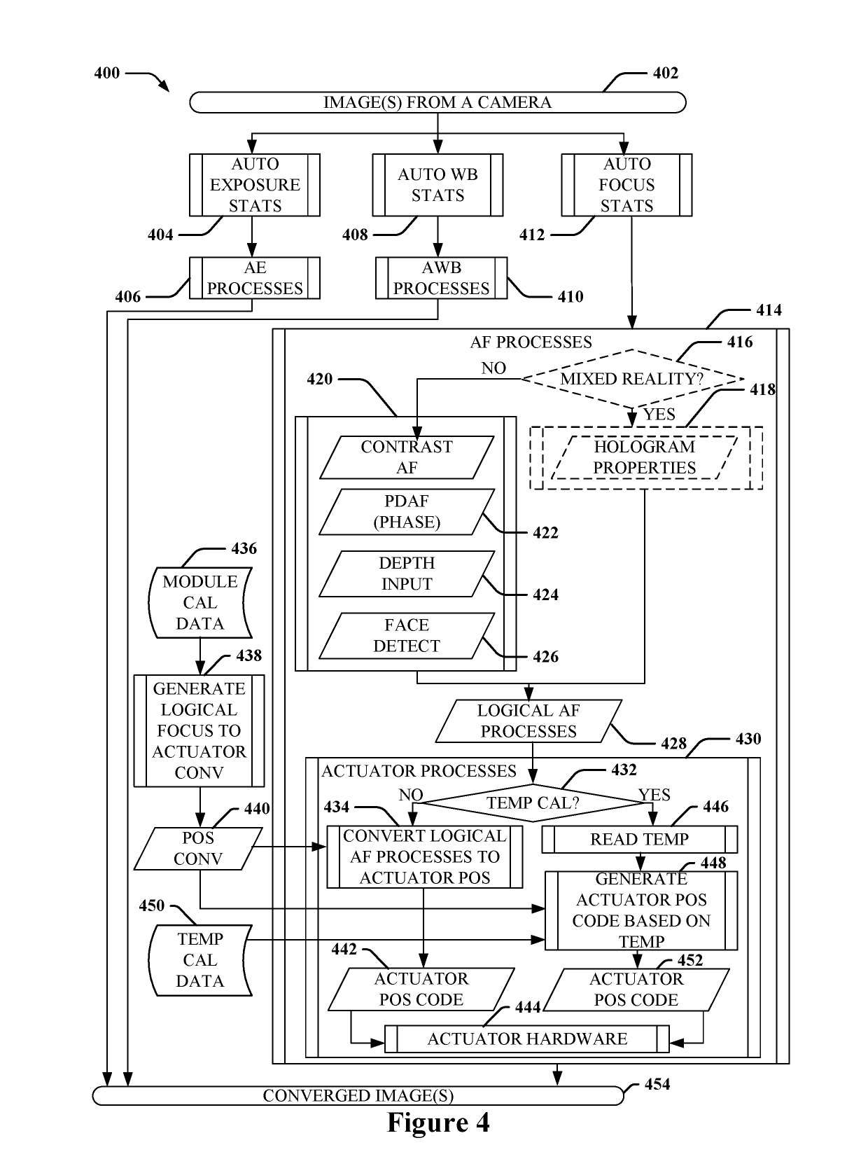

FIG. 4 illustrates an example of a process 400 for processing, e.g., by a camera 106, a computing device 100, a processor 102 of the camera 106 or computing device 100, etc., images generated by a camera, such as camera 106, including auto-focus (AF) processes 414 that may adjust a lens position based on a temperature. Image(s) 402 from a camera can be received and can be input into a plurality of processes, which may be executed sequentially, in parallel, etc., at a processor coupled to the camera 106 (e.g., processor 102) to process the image(s) 402. For example, the image(s) 402 can be provided to an auto exposure (AE) statistics determination process 404 for determining one or more AE parameters to be applied to the image(s) 402, which can be provided to one or more AE processes 406 for applying AE to the image(s) 402. Similarly, for example, the image(s) 402 can be provided to an auto white balance (AWB) statistics determination process 408 for determining one or more AWB parameters to be applied to the image(s) 402, which can be provided to one or more AWB processes 410 for applying AWB to the image(s) 402. Additionally, for example, the image(s) 402 can be provided to an auto focus (AF) statistics determination process 412 for determining one or more AF parameters to be applied to the image(s) 402, which can be provided to one or more AF processes 414 for applying AF to the image(s) 402. The outputs of the AE process 406, AWB process 410, and/or AF process 414 can be combined to produce converged images 454, in one example.

In an example, the one or more AF processes 414 may optionally include a determination of whether the image(s) 402 is/are to be transformed into mixed reality image(s) at 416. For example, this can include a processor 102 determining whether one or more holograms are to be overlaid on the image(s) 402 or not in a mixed reality application. In one example, this determination at 416 may coincide with receiving one or more holograms for overlaying over the image(s) 402. If it is determined that the image(s) 402 are not to include mixed reality, one or more AF adjustments can be made to the image(s) 402. The AF data adjustments can include one or more of a contrast AF adjustment 420 to adjust the auto-focus of a lens of the camera based on a detected contrast of at least a portion of the image(s) 402, a phase detection AF (PDAF) adjustment 422 to adjust the auto-focus of the lens of the camera based on a detected phase of at least a portion of the image(s) 402, a depth input adjustment 424 to adjust the auto-focus of the lens of the camera based on an input or detected depth of one or more objects in the image(s) 402, and/or a face detect adjustment 426 to adjust the auto-focus of the lens of the camera based on a detected face of a person (e.g., a profile of a face) in at least a portion of the image(s) 402.

If it is determined that the image(s) 402 are to be transformed to mixed reality image(s), one or more alternative mixed reality AF adjustments can be made to the image(s) 402 based on the holograms to be overlaid in the image. In an example, these mixed reality alternative AF adjustments may override one or more of the contrast AF adjustment 420, PDAF adjustment 422, depth input adjustment 424, face detect adjustment 426, etc. The mixed reality AF adjustments may include hologram properties 418 applied to the image(s) 402 to adjust the auto-focus of the lens of the camera based on input depth information of a hologram.

In any case, the AF processes 414 can be applied as logical AF processes 428 including performing one or more actuator processes 430 to possibly modify a position of a lens of the camera (e.g., camera 106), which may be based on moving the lens via an actuator (e.g., a focus component 114). In performing the actuator processes 430, it can be determined, at 432, whether temperature calibration is to be performed. If not, the logical AF processes can be used to convert an actuator position code 434. This can include a process to generate a logical focus to actuator conversion 438 based on received module calibration data 436 (which may be defined in the camera 106), which outputs a position conversion result 440 to achieve the logical focus (e.g., based on depth information). The position conversion result 440 can be converted to an actuator position code 442 and provided to actuator hardware 444 (e.g., focus component 114) to move an actuator, which effectively moves the lens of the camera, for capturing one or more images.

Where it is determined that temperature calibration is to be performed at 432, the temperature can be read 446 (e.g., via a temperature sensor 118 at or near the camera 106 or lens 112), and used to generate an actuator position code based on the temperature 448. This can include a process to generate a logical focus to actuator conversion 438 based on received module calibration data 436 (which may be defined in the camera 106), which outputs a position conversion result 440 to achieve the logical focus (e.g., based on depth information). Additionally, in this example, temperature calibration data 450 can be obtained (e.g., from a memory 104), which can include obtaining at least one of a table mapping temperatures or ranges of temperatures to actuator position offsets or ranges of offset for performing auto-focus, function for determining actuator position offsets or ranges of offsets based on the temperature, etc., as described. For example, the actuator position can be generated based on the position conversion result 440 and the temperature calibration data 450, as described above, and can be converted to an actuator position code 452. The actuator position code 452 can be provided to the actuator hardware 444 to move the actuator (and thus the lens) to a desired position for capturing the image.

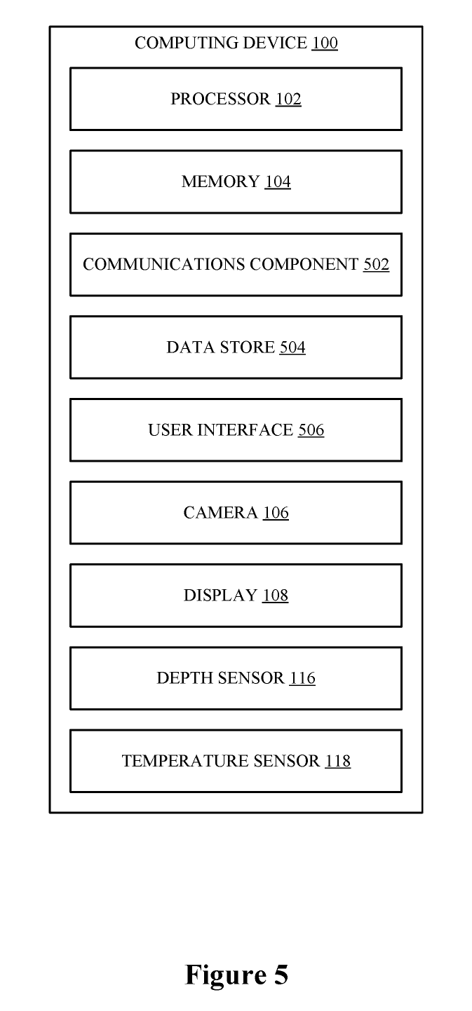

FIG. 5 illustrates an example of computing device 100 including additional optional component details as those shown in FIG. 1. In one aspect, computing device 100 may include processor 102 for carrying out processing functions associated with one or more of components and functions described herein. Processor 102 can include a single or multiple set of processors or multi-core processors. Moreover, processor 102 can be implemented as an integrated processing system and/or a distributed processing system.

Computing device 100 may further include memory 104, such as for storing local versions of applications being executed by processor 102, related instructions, parameters, etc. Memory 104 can include a type of memory usable by a computer, such as random access memory (RAM), read only memory (ROM), tapes, magnetic discs, optical discs, volatile memory, non-volatile memory, and any combination thereof. Additionally, processor 102 and memory 104 may include and execute function related to camera 106 (e.g., focus component 114) and/or other components of the computing device 100.

Further, computing device 100 may include a communications component 502 that provides for establishing and maintaining communications with one or more other devices, parties, entities, etc. utilizing hardware, software, and services as described herein. Communications component 502 may carry communications between components on computing device 100, as well as between computing device 100 and external devices, such as devices located across a communications network and/or devices serially or locally connected to computing device 100. For example, communications component 502 may include one or more buses, and may further include transmit chain components and receive chain components associated with a wireless or wired transmitter and receiver, respectively, operable for interfacing with external devices.

Additionally, computing device 100 may include a data store 504, which can be any suitable combination of hardware and/or software, that provides for mass storage of information, databases, and programs employed in connection with aspects described herein. For example, data store 504 may be or may include a data repository for applications and/or related parameters not currently being executed by processor 102. In addition, data store 504 may be a data repository for focus component 114, depth sensor 116, temperature sensor 118, and/or one or more other components of the computing device 100.

Computing device 100 may also include a user interface component 506 operable to receive inputs from a user of computing device 100 and further operable to generate outputs for presentation to the user (e.g., via display 110 or another display). User interface component 506 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, any other mechanism capable of receiving an input from a user, or any combination thereof. Further, user interface component 506 may include one or more output devices, including but not limited to a display interface to display 110, a speaker, a haptic feedback mechanism, a printer, any other mechanism capable of presenting an output to a user, or any combination thereof.

Computing device 100 may additionally include a camera 106, as described, for capturing images using a lens that can be adjusted based on temperature, a depth sensor 116 for setting a depth at which the camera 106 is to focus, and/or a temperature sensor 118 for measuring temperature at/near camera 106 or a lens thereof. In addition, processor 102 can execute, or execute one or more drivers related to, camera 106, depth sensor 116, temperature sensor 118, or related drivers, functions, etc., and memory 104 or data store 504 can store related instructions, parameters, etc., as described.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computing device, comprising:
a camera comprising a lens configured to capture a real world scene for storing as a digital image; and
at least one processor configured to:
determine a temperature related to the lens of the camera;
apply, based on the temperature, an offset to at least one of a lens position or a range of lens positions defined for the lens; and
perform a focus of the lens based on at least one of the lens position or the range of lens positions.

2. The computing device of claim 1, wherein the at least one processor is further configured to determine the offset from a table associating a plurality of offsets with a plurality of temperatures or ranges of temperatures.

3. The computing device of claim 1, wherein the at least one processor is further configured to determine the offset as a linear or non-linear function of the temperature.

4. The computing device of claim 1, wherein the at least one processor is further configured to determine a reference temperature at which the lens position or the range of lens positions are calibrated, and to determine the offset based at least in part on a difference between the temperature and the reference temperature.

5. The computing device of claim 4, wherein the at least one processor is configured to determine the offset as a linear or non-linear function of the difference between the temperature and the reference temperature.

6. The computing device of claim 4, wherein the at least one processor is configured to determine the offset based on a table mapping offsets to differences between the temperature and the reference temperature.

7. The computing device of claim 1, wherein the at least one processor is configured to perform the focus as an auto-focus based on the range of lens positions.

8. The computing device of claim 1, wherein the at least one processor is further configured to receive depth information for performing the focus at a specified depth, and to set the lens position or the range of lens positions for performing the focus based on the offset and the specified depth.

9. The computing device of claim 8, wherein the depth information is based on a hologram depth of a hologram for displaying for a mixed reality image, and wherein the at least one processor is further configured to display the real world scene with the hologram positioned at the hologram depth.

10. The computing device of claim 1, wherein the temperature is at least one of an operating temperature of the lens of the camera or an ambient temperature measured near the lens of the camera.

11. A method for focusing a lens of a camera, comprising:
determining a temperature related to the lens of the camera;
applying, based on the temperature, an offset to at least one of a lens position or a range of lens positions defined for the lens; and
performing a focus of the lens based on at least one of the lens position or the range of lens positions.

12. The method of claim 11, further comprising determining the offset from a table associating a plurality of offsets with a plurality of temperatures or ranges of temperatures.

13. The method of claim 11, further comprising determining the offset as a linear or non-linear function of at least the temperature.

14. The method of claim 11, further comprising determining a reference temperature at which the lens position or the range of lens positions are calibrated, and determining the offset based at least in part on a difference between the temperature and the reference temperature.

15. The method of claim 11, wherein performing the focus is based on performing an auto-focus based on the range of lens positions.

16. The method of claim 11, further comprising:
receiving depth information for performing the focus at a specified depth; and
setting the lens position for performing the focus based on the specified depth.

17. The method of claim 11, wherein the temperature is at least one of an operating temperature of the lens of the camera or an ambient temperature measured near the lens of the camera.

18. A non-transitory computer-readable medium comprising code for focusing a lens of a camera, the code comprising:
code for determining a temperature related to the lens of the camera;
code for applying, based on the temperature, an offset to at least one of a lens position or a range of lens positions defined for the lens; and
code for performing a focus of the lens based on at least one of the lens position or the range of lens positions.

19. The non-transitory computer-readable medium of claim 18, further comprising code for determining the offset from a table associating a plurality of offsets with a plurality of temperatures or ranges of temperatures.

20. The non-transitory computer-readable medium of claim 18, further comprising code for determining the offset as a linear or non-linear function of at least the temperature.
